(19) United States
(12) Patent Application Publication
(10) Pub. No.: US 2004/0075344 A1
(43) Pub. Date: Apr. 22, 2004

(54) Means for providing intelligence to multiple electro-mechanical point of use transfer switches

(76) Inventor: Nilo L. Villarin, Great Falls, VA (US)

Correspondence Address: Roland H. Shubert, Post Office Box 2339, Reston, VA, 20195-0339, US

(21) Appl. No.: 10/674,595

(22) Filed: Sep. 30, 2003

Related U.S. Application Data
(60) Provisional application No. 60/415,333, filed on Oct. 1, 2002.

(51) Int. Cl. H02J 7/00

(52) U.S. Cl. 307/64

(57) ABSTRACT

A point of use transfer switch array to simultaneously switch a plurality of loads from a first primary power source to a second power source in the event that the primary source is lost, becomes corrupted, or otherwise deviates from predetermined specifications includes two logic modules, one for each power source, each logic module controlling the operation of a plurality of switches, one switch for each load. The switches may be coil-activated, double throw electromechanical relays that drop from one throw position to a second throw position upon a reduction of voltage across the relay coil.

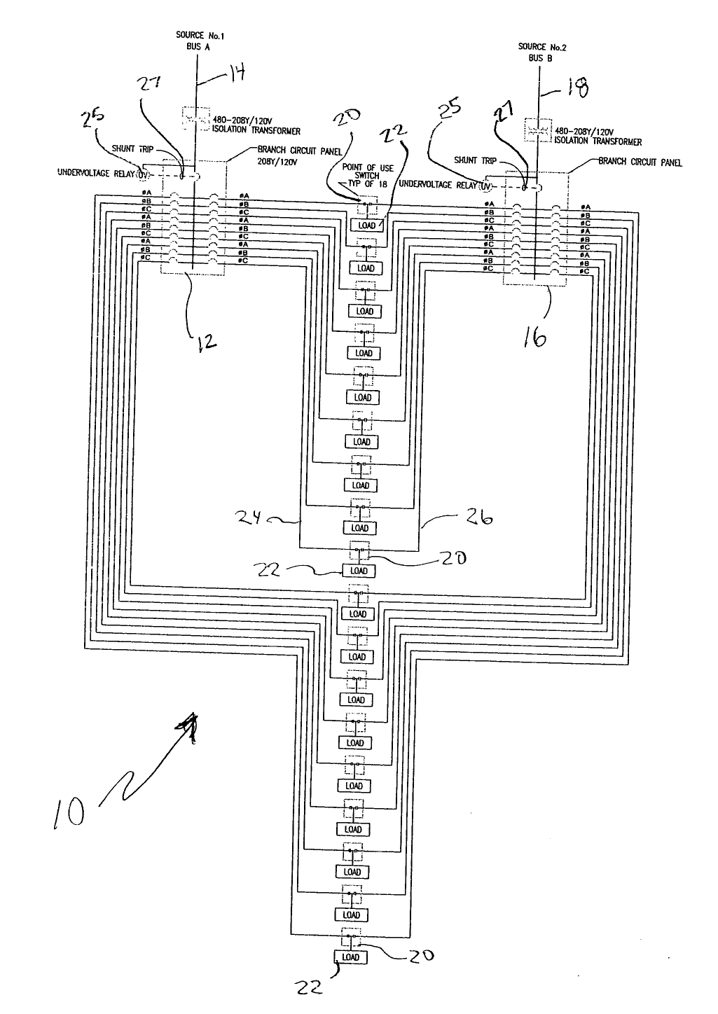

### REFERENCE TO RELATED APPLICATION

This application claims the benefit of U.S. Provisional Patent Application No. 60/415,333 that was filed Oct. 1, 2002.

### BACKGROUND OF THE INVENTION

1. Technical Field

This invention relates to a means for providing automatic transfer switches that employ a plurality of small electromechanical double throw relays, and to a method for their use.

More particularly, this invention relates to a method and means to control the switching of a plurality of electrical loads by providing intelligence to small electromechanical relays causing those relays to switch the load served by each relay from a first input source to an alternate input source in the event that the first input source fails, is corrupted, or goes out of tolerance.

2. Description of Related Art

The electrical power distribution industry employs devices known as “point of use transfer switches” to switch a load from a first power source to a second, or alternate, power source in the event that the first source is lost, becomes corrupted, or goes out of tolerance. Point of use transfer switches for the control of a single load that are commercially available at this time typically consist of either a solid state or an electromechanical device that carries the complex intelligence or logic for determining the integrity of the preferred and alternate power sources. In the event that the switch with its associated logic detects an unacceptable condition occurring in the primary, or preferred input power source, it activates the switch to disconnect the primary input and replace it with a secondary, or back-up, power source.

### SUMMARY OF THE INVENTION

This invention provides an array of point of use transfer switches, each switch including an electromechanical double throw relay carrying logic that is sufficient only to determine the virtually complete loss of either the first or the alternate power source. Monitoring of input power sources to determine whether the source has been corrupted or has deviated from predetermined specifications is conducted at a branch circuit panel board or module located upstream from the relays. That branch circuit module is provided with an independent and more complex logic algorithm that can detect a number of out-of-tolerance power parameters. Once the branch circuit module deems a power source to be out-of-tolerance or otherwise unacceptable, it trips a circuit breaker that controls power input to the panel board module. The electromechanical relay of each transfer switch will then detect the resulting power loss, and each transfer switch will then go to the alternate source. That arrangement allows one logic module to control the switching of multiple separate loads thus providing a simpler and more economical system than does present practice.

### BRIEF DESCRIPTION OF THE DRAWING

The single FIGURE comprises a line diagram of the switch array of this invention.

### DESCRIPTION OF PREFERRED EMBODIMENTS OF THE INVENTION

A preferred embodiment of this invention comprises a point of use transfer switch array 10 that includes a first branch circuit panel board module 12 that controls the distribution of current from a first, or primary, source 14, and a second branch circuit panel board 16 that controls the distribution of current from a different, or secondary, source 18. Each circuit panel board module, 12 and 16, is arranged to supply power to a plurality of individual point of use switches 20 by way of conductors 24 and 26 respectively and each switch, in turn, controls its respective load 22.

For the purposes of illustration, eighteen switches are shown in the FIGURE but that number may be lesser or greater in actual practice of the invention. Switches 20, for this application, are typically rated between about 10 and 30 amperes at 120 volts, 208 volts, or 240 volts, either single phase or three phase. The switches employ electromechanical relays that preferably will drop out only when the switch coil voltage is reduced to a very low level, typically 10% or less of the nominal voltage. Switches 20, in the first throw position, allow current to flow from control module 12, through the switch coils, and through the loads 22, and in the second throw, or drop out, position allow current to flow from control module 16 through the switch coils and though the loads 20.

Monitoring of the input sources 14 and 18 to determine whether either is out of tolerance is a much more complex operation. In this invention, that monitoring operation is performed by intelligence, or logic, means that are associated with or integral to the branch circuit panel modules 12 and 16 which are locate immediately upstream from the switches 20. Module 12 is arranged to accept power from the primary source 14 and to monitor selected parameters of that source, while module 116 is arranged to accept power from the secondary source 18 and to monitor selected parameters of that source. The electrical parameters monitored by the logic contained in the two panel modules may be, and in most cases are, identical but it is possible to arrange the logic means to monitor different parameters of the two power sources.

In its simplest form, the intelligence or logic means associated with panel modules 12 and 16 may comprise an undervoltage relay 25 or it may comprise a more complex detection algorithm that can determine a number of out of tolerance current parameters. For example, the module logic algorithm may include a timing parameter to determine whether a loss in voltage is momentary or is likely to be prolonged. Some types of loads are relatively indifferent to a momentary reduction in voltage while other types of loads, such as computers and other electronic equipment, require very rapid transfer of power sources to avoid disruption. Additionally, the logic algorithm may be arranged to detect the failure of only one phase of a three phase system, and to initiate transfer from one power source to the other upon detection of that event.

Once the source 14 or 18 is deemed unacceptable by the logic means contained in either circuit module 12 or 16, a signal is generated that will cause the main circuit breaker of the panel to be shunt tripped by means 27. Upon the tripping of the main circuit breaker by operation of means 27, each of the switches 20 will detect the loss of power from the in-use source and will then go to the alternate source.

As may now be appreciated the point of use transfer array of this invention, that provides monitoring of power supply integrity only in each panel board module serving a plurality of switches rather than at each individual switch, will be more simple and economical than is the present technology. It is to be understood that variations and modifications of the invention, in addition to those specifically described, will be apparent to those skilled in the art and are included within the scope of the invention as is defined by the following claims.

I claim:

1. Means to control the switching of a plurality of electrical loads from a primary power source to a secondary power source upon corruption of said primary source, comprising:
a first logic means that is arranged to accept power from said primary source and to monitor selected parameters of said power source;
first circuit breaker means communicating with said first logic means and arranged to interrupt power flow from said primary source upon the detection by the logic means of an out of tolerance current parameter;
a second logic means that is arranged to accept power from said secondary source and to monitor selected parameters of said power source;
second circuit breaker means communicating with said second logic means and arranged to interrupt power flow from said secondary source upon the detection by the logic means of an out of tolerance current parameter;
a plurality of electrical loads, each of said loads arranged to accept power either from said primary power source or from said secondary power source;
a plurality of switches, one switch for each said power means, each of said switches comprising a coil-activated, double throw electromechanical relay that will drop out of a first throw position to a second throw position upon a reduction of voltage across said coil, each said relay in its first throw position allowing current to flow from said primary source through said relay coils and to said load, each said relay in its second throw position allowing current to flow from said secondary source through said relay coils and to said load.

2. The means of claim 1 wherein a parameter monitored by said first logic means is the voltage of the primary power source.

3. The means of claim 1 wherein said primary power source is three phase, and a parameter monitored by said first logic means is the failure of one phase of said three phase source.

4. The means of claim 1 wherein a parameter measured by said second is the voltage of the secondary power source.

5. The means of claim 1 wherein said secondary power source is three phase, and a parameter monitored by said second logic means is the failure of one phase of said three phase source.

6. The means of claim 1 wherein the parameters monitored by the first logic means are the same as the parameters monitored by the second logic means.

7. The means of claim 1 wherein the parameters monitored by the first logic means are different from those parameters monitored by the second logic means.

8. The means of claim 1 wherein said relay drops out of a throw position upon a reduction of voltage across said relay coil to a level less than 10% of nominal voltage.
